(19) United States
(12) Patent Application Publication
(10) Pub. No.: US 2008/0002981 A1
(43) Pub. Date: Jan. 3, 2008

(54) GROUND TO SPACE TO GROUND TRUNKING SYSTEM

(75) Inventors: George C. Valley, Los Angeles, CA (US); Thomas S. La France, Manhattan Beach, CA (US); Wah L. Lim, Santa Ana, CA (US)

Correspondence Address: THE DIRECTV GROUP, INC.;PATENT DOCKET ADMINISTRATION, CA / LA1 / A109, P O BOX 956, EL SEGUNDO, CA, 90245-0956, US

(73) Assignee: THE DIRECTV GROUP, INC., El Segundo, CA (US)

(21) Appl. No.: 11/854,449

(22) Filed: Sep. 12, 2007

Related U.S. Application Data
(63) Continuation of application No. 09/565,296, filed on May 4, 2000, now abandoned.

(51) Int. Cl. H04B 10/105; H04J 14/00

(52) U.S. Cl. 398/121; 398/122; 398/124; 398/125; 398/68

(57) ABSTRACT

A satellite trunking system has a satellite for sending and receiving optical signals. A first ground station is positioned on a first land mass and a second ground station is positioned on a second land mass. Each ground station communicates to the other ground stations through the satellite using optical signals.

### CROSS-REFERENCE TO RELATED APPLICATIONS

This application is a continuation of U.S. patent application Ser. No. 09/565,296 filed on May 4, 2000. The disclosure of the above application is incorporated herein by reference.

### TECHNICAL FIELD

The present invention relates generally to trunking systems for communication between two continents. More specifically, the present invention relates generally to a trunking system using a satellite as a component of the system.

### BACKGROUND

The statements in this section merely provide background information related to the present disclosure and may not constitute prior art.

Communication systems between continents are referred to as a trunking system. Currently, submarine fiber systems are employed to couple the communication systems of continents together. The submarine fiber systems, however, are expensive and time consuming to construct.

The submarine fiber systems use optical fibers and employ wavelength division multiplexing (WDM) technology. Wavelength division multiplexing allows multiple signals to be transmitted on an optical fiber, each signal using a different wavelength for communication.

The distance across an ocean is substantial. One problem with using a long length of fiber with densely space wavelengths is a phenomenon known as four-wave mixing. Four-wave mixing is a non-linear optical effect that reduces the effectiveness of the fiber.

Another method for continent to continent communication contemplated is the use of a satellite using radio frequency signals for communication. One problem associated with using radio frequency systems is limited by the bandwidth. That is, satellite communications to ground are licensed and, therefore, the amount of bandwidth needed for a trunking system would likely not be licensed due to its breadth. Another problem associated with radio frequency communication is that the power available on the spacecraft (satellite) is limited. Thus, to handle a large amount of signals, a large amount of power must be available. Yet, another problem with radio frequency communications is that to handle a large number of signals, the size of the on-board antennas must be increased. Increasing size and weight increase the expense of a satellite program. Also, the phased array antenna technology used for satellite communications is limited in terms of the quantity of signals required for intercontinental communications. Radio frequencies above about 100 GHz are currently available. One problem with such frequencies is that they appear to be unusable because atmospheric attenuation is very high.

In terrestrial wavelength division multiplexing systems, independent streams of data are sent on separate wavelengths over the same fiber. The power of each wavelength is modulated independently. The wavelengths are then combined by optical multiplexing devices. The whole set of wavelengths is amplified together in a single amplifier and injected into a long-haul fiber. Additional amplifiers must be spaced apart along the length of the wire so that the signal is not reduced. To add to the complexity, the amplifiers and fibers are submerged into the ocean. Therefore, the amplifiers and wires must be able to withstand the harsh environmental conditions at the bottom of the ocean.

### SUMMARY

It is an object of the invention to provide a trunking system employing a satellite for intercontinental communications. It is a further object of the invention to provide an optical system for ground to space to ground trunking.

In one aspect of the invention, an optical trunking system includes a satellite for sending and receiving optical signals. A first ground station is positioned on a first land mass and a second ground station is positioned on a second land mass. Each ground station communicates to the other ground stations through the satellite using optical signals.

In a further aspect of the invention, a method for communicating between two land masses comprises the steps of: generating an optical signal at a first land mass; directing the optical signal to a first satellite; receiving the optical signal; directing the optical signal to a ground station at a second land mass; and receiving the optical signal at the second ground station.

One advantage of the invention is that optical signals may be employed which are not regulated for satellite communications. Another advantage of the invention is that wavelength division multiplexing in free space is not limited by four-wave mixing. Another advantage of the invention is that cloud obscuration may be overcome by employing multiple ground sites over a predetermined area for the sending and receiving of the optical signals.

Other objects and advantages of the present invention will become apparent when viewed in light of the detailed description of the preferred embodiment when taken in conjunction with the attached drawings and appended claims.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a communication system according to the present invention.

FIG. 2 is a perspective view of an alternative communication system according to the present invention.

FIG. 2 is a plan view of a ground system employed in a satellite communication system according to the present invention.

FIG. 4A is a block diagram schematic view of a ground station transmitting system.

FIG. 4B is a block diagram schematic view of a ground station receive circuit according to the present invention.

FIG. 5 is a block diagram schematic view of the communication circuit employed in a satellite system of a communication system according to the present invention.

### DETAILED DESCRIPTION

The present invention is described herein relative to a trunking system. However, one skilled in the art would recognize that the teachings of the present invention may also be suitable for other types of satellite communications.

Referring now to FIG. 1, a satellite trunking system 10 is illustrated having a single satellite 12 that is in communication with a first ground system 14 and a second ground system 16. Satellite 12 is preferably a geostationary earth orbit satellites (GEO). However, the teaching may also be applied to satellites having other orbits such as Medium Earth Orbit (MEO) or Low Earth Orbit (LEO). The first ground system 14 is located on a first landmass 18 on the earth 20. The second ground system 16 is located on a second landmass 22. Each landmass, for example, may be separate continents divided by an ocean. Each ground system 14, 16 communicates with a terrestrial network such as a phone network.

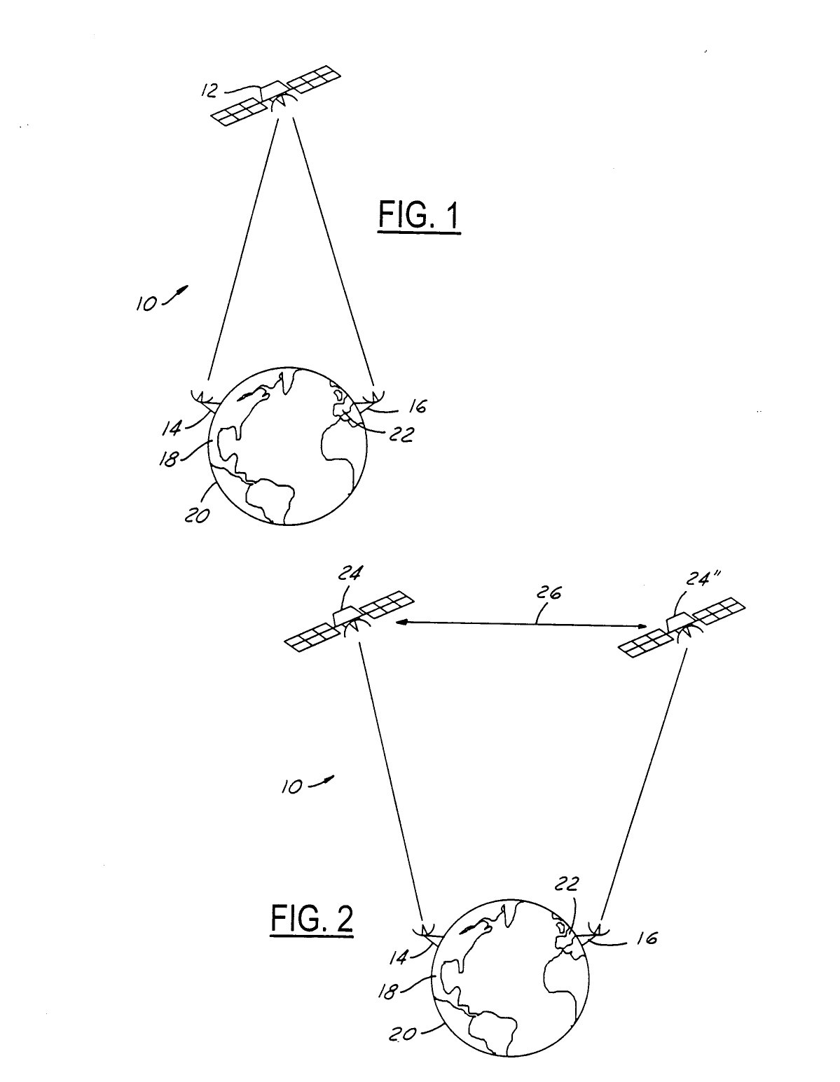

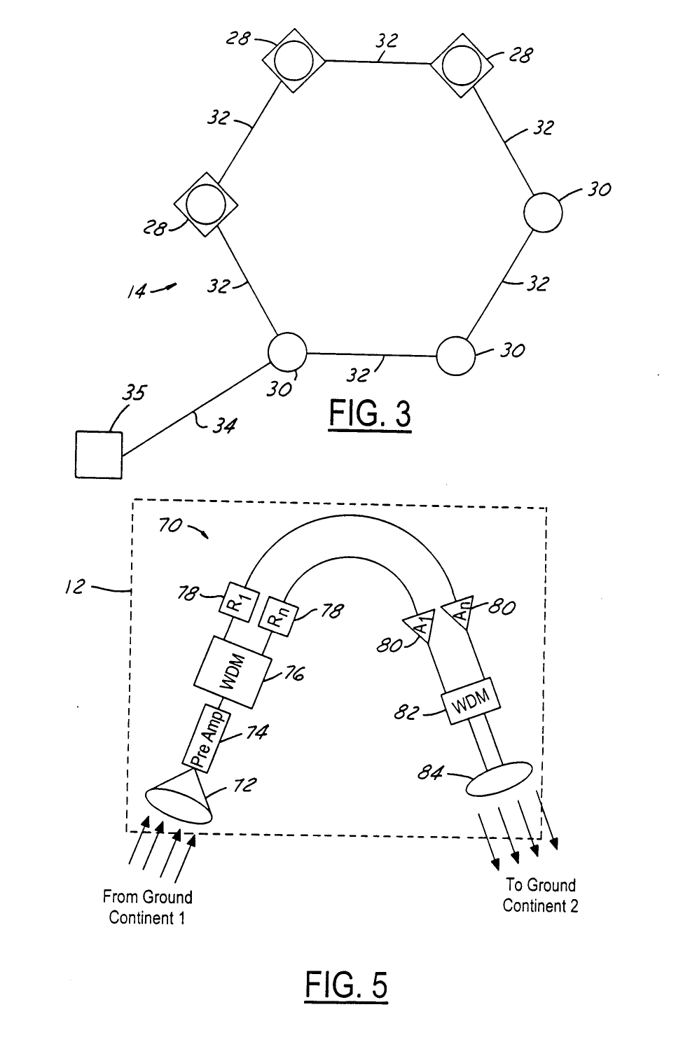

Referring now to FIG. 2, satellite trunking system 10 may incorporate a pair of satellites 24, 24″. By using a pair of satellites 24, 24″, each satellite 24, 24″ may be interconnected through an optical link 26. Using a pair of satellites 24, 24″ such as that shown in FIG. 2, is particularly useful when spanning a longer distance than that of FIG. 1. By using two satellites, the elevation angle at first ground system 14 and second ground system 16 may be increased. Also, by increasing the elevation angle, atmospheric affects on the signals between satellites 24, 24″ and first ground system 14 and second ground system 16 are reduced.

Referring now to FIG. 3, the layout of a first ground system 14 is generally shown. First ground system 14 and second ground system 16 may each be configured the same. First ground system 14 is comprised of ground telescope buildings 28 and feed nodes 30. Feed nodes 30 include a ground telescope and also include a terrestrial fiber feed 34. Although three ground telescope buildings and three feed nodes 30 are shown, various numbers of ground telescope buildings 28 and feed nodes 30 may be employed. Ground telescope buildings 28 and feed nodes 30 are coupled by a fiber optic ring network 32. As illustrated, fiber optic ring network 32 is hexagonal in shape, having a ground telescope building 28 or feed node 30 at a respective corner. In a preferred embodiment, the distance of each section of fiber optic ring network 32 is 100 kilometers. By spacing each ground telescope building 28 and feed node 30 a substantial distance apart, it is likely that at least one site in each of first ground system 14 and second ground system 16 will have a cloud-free line of sight to the satellite.

Terrestrial fiber feed 34 is connected to a conventional land-based communication system. Fiber feed 34 provides the link to a terrestrial network 35, such as a phone system. Each ground system on each landmass is coupled to a separate terrestrial network.

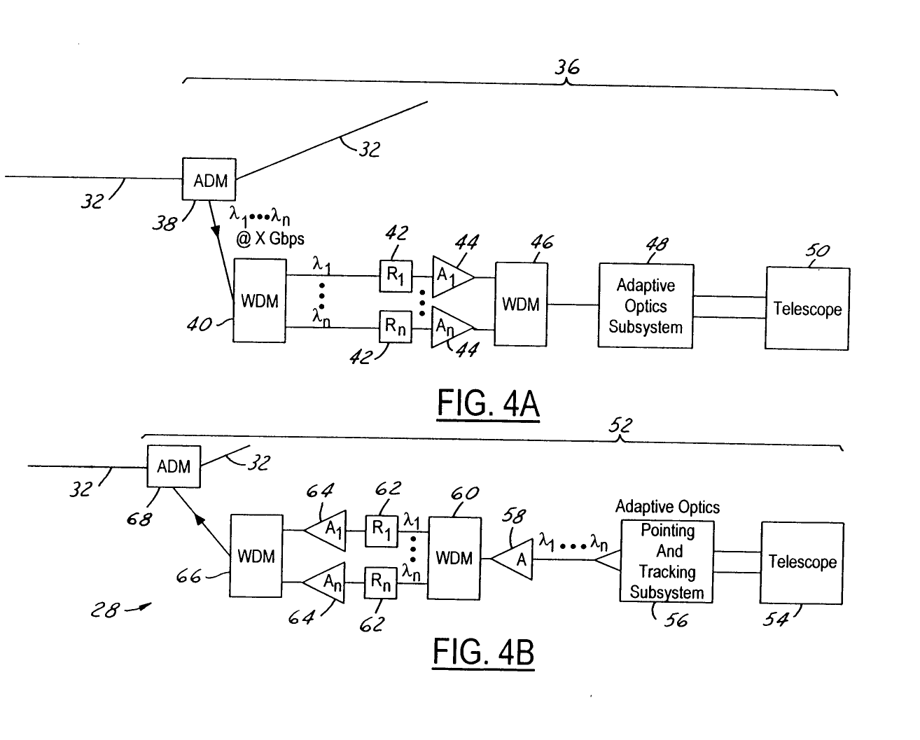

Referring now to FIG. 4A, a general block diagram of a transmitting circuit 36 for a ground telescope building 28 is illustrated. Transmitting circuit 36 has an add/drop multiplexer (ADM) 38 that is used to couple various wavelengths 8₁ through 8ₙ at a predetermined gigabit rate per second. Add/drop multiplexers 38 remove each of the desired wavelengths simultaneously from fiber optic ring network 32. A wave division demultiplexer (WDM) 40 is coupled to add/drop multiplexer 38. Wave division demultiplexer divides the signal into its component parts, namely into each wavelength 8₁ through 8ₙ. Wave division demultiplexer 40 is coupled to a regeneration circuit 42. Preferably, one regeneration circuit 42 is provided for each wavelength. Regeneration circuit 42 may provide optical or electrical regeneration to each wavelength. An amplifier 44 is coupled to each regeneration circuit 42. Amplifier 44 may, for example, be an erbium doped fiber amplifier or amplifier chain. Each of the signal wavelengths are then coupled to a wavelength division multiplexer (WDM) 46 which recombines the signals into a single amplified signal.

Wavelength division multiplexer 46 is coupled to an adaptive optics subsystem 48 which is then coupled to a telescope 50. Telescope 50 transmits the optical signals to satellite 12. Adaptive optics 48 are used in conjunction with telescope 50 due to atmospheric turbulence which causes deleterious effects on the uplink and downlink signals. On the uplink, turbulent refractive index fluctuations cause beam wander or jitter, beam breakup and scintillation. Beam wander may be corrected by using a fast tracking telescope system. Beam breakup can be corrected with adaptive optics subsystem 48. Scintillation can be improved by averaging techniques on the signal. Various types of adaptive optic subsystems 48 are known to those skilled in the art. Thus, adaptive optics subsystem 48 is used to compensate for differences in the movement of the spacecraft and aberrations due to the atmosphere.

Referring now to FIG. 4B, a receiving circuit 52 of ground telescope building 28 is illustrated. Receiving circuit 52 has a receiving telescope 54 coupled to an adaptive optics subsystem 56 that includes a pointing and tracking subsystem to direct telescope 54 toward a satellite. Adaptive optics subsystem 56 operates in a similar manner to that of adaptive optics subsystem 48 compensates the pointing of telescope 54 for atmospheric turbulence. Turbulence on the downlink may cause beam wander and break-up which decreases the power into the system. Adaptive optics subsystem 48 precompensates a beam for aberrations due to turbulence so that after propagation through turbulence, the beam is nearly diffraction limited.

Adaptive optic subsystem 56 is coupled to a preamplifier 58. Preamplifier 58 amplifies the entire beam including each of the wavelengths included in the received beam. Preamplifier 58 is coupled to a wave division demultiplexer (WDM) 60 which divides the signals in a similar manner to that described above in FIG. 4A. Wave division demultiplexer 60 is coupled to a regeneration circuit 62, an amplifier 64, and a wave division multiplexer (WDM) 66. Wave division multiplexer is coupled to an add/drop circuit (ADM) 68. Add/drop circuit 68 adds the received wavelengths to fiber optic ring network 32. Wave division demultiplexer 60, regeneration circuit 62, amplifier 64, and wave division multiplexer 66, operate in a similar manner to that described above in FIG. 4A.

Referring now to FIG. 5, a satellite communication circuit 70 within satellite 12 is illustrated. Satellite communication circuit 70 has a receive telescope 72 coupled to a preamplifier 74. A wave division multiplexer (WDM) 76 is coupled to preamplifier 74. Preamplifier 74 amplifies the received wavelengths from receive telescope 72. Wave division demultiplexer 76 breaks the received signal into its component wavelengths and is coupled to regeneration circuits 78. Regeneration circuits 78 are coupled to amplifiers 80. Preferably, one regeneration circuit and one amplifier 80 are provided for each communication wavelength.

Each amplifier 80 is coupled to a wavelength division multiplexer (WDM) 82 which reassembles the amplified signals from amplifier 80. Wave division multiplexer 82 is coupled to transmitting telescope 84. Transmitting telescope 84 is directed to the second ground system which is preferably on a second continent. Transmitting telescope 84 transmits a signal having each active communication wavelength. Preamplifier 74, wave division multiplexer 76, regeneration circuit 78, amplifiers 80 and wave division multiplexer 82 all operate in a similar manner to that described in FIGS. 4A and 4B. However, wave division multiplexer 82 is coupled to a transmitting telescope 84 rather than to an add/drop multiplexer.

In operation, using wave division multiplexing in a satellite communication system, a much larger path loss is associated with that compared to terrestrial systems. To overcome path losses, several approaches may be taken separately or in combination. For example, higher power erbium doped fiber amplifiers (EDFAs), large aperture telescopes to focus the light, or the use of a single EDFA per wavelength with multiplexing after amplification may be employed. In one embodiment, all of these techniques may be used in combination to transmit 2.5 Gbps to a GEO spacecraft with a bit error rate of 10⁻⁶.

Each continent preferably has a ground system such as one similar to that of FIG. 3. Each ground station is coupled to a terrestrial fiber feed for receiving and transmitting information from a communications infrastructure. The communication infrastructure may include public terrestrial phone networks as well as corporate terrestrial phone networks. Each ground station may potentially communicate with the satellite. Each ground system 14, 16, measures the amount of cloud cover in the path between each ground telescope building 28 or feed node 30 and satellite 12. The least distorted path is chosen for transmitting and receiving communication signals from the satellite 12. Optical signals may be input directly from a terrestrial fiber feed 34 into fiber optic ring network 32. The signals travel rapidly through fiber optic ring network 32 and are directed to the ground telescope building 28 having the clearest path to satellite 12. The optical signals are then generated and transmitted through the telescope into satellite 12. Satellite 12 receives the optical signals, amplifies the optical signals, and retransmits the optical signals to the second ground system on a second continent. If the elevation angle is too low due to a great distance between first ground system and second ground system, a second or more satellites may be incorporated into the system. In such a manner, transmitting telescope 84 may be directed to transmit information to the second satellite rather than to the second ground system.

While particular embodiments of the invention have been shown and described, numerous variations and alternate embodiments will occur to those skilled in the art. Accordingly, it is intended that the invention be limited only in terms of the appended claims.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification and the following claims.

What is claimed is:

1. A system comprising:
a first ground system comprising,
an optical transmitting circuit comprising,
a transmitting add drop multiplexer removing a plurality of optical wavelengths from a first optical network to form a first optical signal;
a transmitting wave division demultiplexer in communication with the transmitting add drop multiplexer forming a plurality of different transmitting wavelength signals corresponding to wavelengths from the first optical signal;
a plurality of transmitting regeneration circuits in communication with a respective one of the wave division demultiplexers generating a transmitting regenerative signal for each of the plurality of different transmitting wavelength signals;
a plurality of transmitting amplifiers in communication with a respective one of the plurality of transmitting regeneration circuits forming transmitting amplified regenerated signals;
a transmitting wave division multiplexer multiplexing the transmitting amplified regenerated signals to form a transmitting multiplexed signal; and
a transmitting telescope transmitting the transmitting multiplexed signal.

2. A system as recited in claim 1 wherein the optical transmitting circuit comprises a transmitting adaptive optics subsystem receiving the transmitting multiplexed signal and forming a transmitting compensated multiplexed signal, said transmitting telescope transmitting the transmitting compensated signal.

3. A system as recited in claim 2 wherein the transmitting compensated signal compensates for atmospheric aberrations.

4. A system as recited in claim 1 wherein the transmitting telescope transmits the multiplexed signal to a satellite.

5. A system as recited in claim 4 wherein the transmitting compensated signal compensates for movement of the satellite.

6. A system as recited in claim 1 wherein the first ground station comprise an optical receiving circuit comprising,
a receiving telescope receiving a second optical signal;
a receiving wave division demultiplexer in communication with the receiving telescope forming a plurality of different receiving wavelength signals corresponding to wavelengths from the second optical signal;
a plurality of receiving regeneration circuits in communication with a respective one of the receiving wave division demultiplexers generating receiving regenerative signals;
a plurality of receiving amplifiers in communication with a respective one of the plurality of receiving regeneration circuits forming receiving amplified regenerated signals;
a receiving wave division multiplexer multiplexing the receiving amplified regenerated signals to form a receiving multiplexed signal; and
a receiving add drop multiplexer adding the received multiplexed signal to the first optical network.

7. A system as recited in claim 6 wherein the optical receiving circuit comprises an receiving adaptive optics subsystem receiving the second optical signal and forming a receiving compensated signal.

8. A system as recited in claim 7 wherein the receiving compensated signal compensates for atmospheric aberrations.

9. A system as recited in claim 7 wherein the receiving telescope receives the second signal from a satellite.

10. A system as recited in claim 9 wherein the receiving compensated signal compensates for movement of the satellite.

11. A system as recited in claim 6 wherein the receiving telescope receives the second signal from a satellite system and the transmitting telescope transmits the transmitting multiplexed signal to the satellite system.

12. A system as recited in claim 11 wherein the first ground system is disposed on a first landmass coupled to a first terrestrial network through the first optical network, said first ground system having a first plurality of ground stations optically coupled to the first optical network, each of the plurality of ground station comprising the optical transmitting circuit and the optical receiving circuit.

13. A system as recited in claim 11 wherein said first ground system determining a first ground station having a first least distorted path between the satellite system and the first plurality of ground stations.

14. A system as recited in claim 11 wherein the first optical network comprising an optical ring network.

15. A system as recited in claim 12 wherein a second ground system is disposed on a second landmass coupled to a second terrestrial network and optically coupled to the satellite system.

16. A system as recited in claim 15 wherein said second ground system comprising a second plurality of optically coupled ground stations.

17. A system as recited in claim 16 wherein said second ground system determines a second ground station having a second least distorted path between the satellite system and the second plurality of ground stations, said second ground system communicating with said first ground system through said satellite system and the first path and the second path.

18. A system as recited in claim 17 wherein said satellite system comprises at least a first satellite and a second satellite optically coupled to said first satellite, said second satellite is in communication with said second ground system and said first satellite is in communication with said first ground system.

19. A method comprising:
removing a plurality of optical wavelengths from a first optical network to form a first optical signal;
forming a plurality of different transmitting wavelength signals corresponding to various wavelengths from the first optical signal;
generating respective transmitting regenerative signals from each of the plurality of different transmitting wavelength signals;
amplifying each of the transmitting regenerative signals to form transmitting amplified regenerated signals;
multiplexing the transmitting amplified regenerated signals to form a transmitting multiplexed signal; and
optically transmitting the transmitting multiplexed signal.

20. A method as recited in claim 19 further comprising prior to transmitting, forming a transmitting compensated multiplexed signal at a transmitting adaptive optics subsystem to compensate for atmospheric aberrations.

21. A method as recited in claim 19 wherein optically transmitting comprises optically transmitting the multiplexed signal to a satellite through a transmitting telescope and prior to transmitting, forming a transmitting compensated multiplexed signal at a transmitting adaptive optics subsystem to compensate for satellite movement.

22. A method as recited in claim 19 further receiving a second optical signal through a receiving telescope;
forming a plurality of different receiving wavelength signals corresponding to wavelengths from the second optical signal;
generating respective receiving regenerative signals from each of the plurality of different wavelength signals;
amplifying the regenerated signals from each of the respective receiving regenerative signals to form receiving amplified regenerated signals;
multiplexing the receiving amplified regenerated signals to form a receiving multiplexed signal; and
adding the received multiplexed signal to the first optical network.

23. A method as recited in claim 22 wherein prior to forming a plurality of different receiving wavelength signals, forming a receiving compensated signal at a receiving adaptive optics subsystem to compensate for atmospheric aberrations.

24. A method as recited in claim 22 wherein receiving the second optical signal comprises receiving the second signal from a satellite and wherein prior to forming a plurality of different receiving wavelength signals, forming a receiving compensated signal at a receiving adaptive optics subsystem to compensates for atmospheric aberrations movement of the satellite.

25. A method as recited in claim 22 wherein the steps of removing a plurality of optical wavelengths from a first optical network to form a first optical signal, forming a plurality of different transmitting wavelength signals corresponding to various wavelengths from the first optical signal, generating respective transmitting regenerative signals from each of the plurality of different transmitting wavelength signals, amplifying each of the transmitting regenerative signals to form transmitting amplified regenerated signals, multiplexing the transmitting amplified regenerated signals to form a transmitting multiplexed signal, and optically transmitting the transmitting multiplexed signal are performed at a first plurality of ground stations on a first landmass;
and wherein optically transmitting the transmitting multiplexed signal comprises optically transmitting the transmitted multiplexed signal to a satellite from one of the first plurality of ground stations; and
communicating the transmitting multiplexed signal to a second plurality of ground stations on a second land mass.
